(19) United States
(12) Patent Application Publication
(10) Pub. No.: US 2008/0178609 A1
(43) Pub. Date: Jul. 31, 2008

(54) COMBINED COOLING AND HEATING SYSTEM

(75) Inventors: Claus Hoffjann, Hamburg (DE); Hansgeorg Schuldzig, Jork (DE)

Correspondence Address: CHRISTOPHER PARADIES, PH.D., FOWLER WHITE BOGGS BANKER, P.A., 501 E KENNEDY BLVD, STE. 1900, TAMPA, FL, 33602, US

(73) Assignee: Airbus Deutschland GmbH, Hamburg (DE)

(21) Appl. No.: 11/782,039

(22) Filed: Jul. 24, 2007

Related U.S. Application Data
(60) Provisional application No. 60/820,122, filed on Jul. 24, 2006.

(30) Foreign Application Priority Data
Jul. 24, 2006 (DE) 10 2006 034 194.5

(51) Int. Cl. F25B 29/00; F25B 19/00; C09K 5/00

(52) U.S. Cl. 62/7; 62/159; 62/114

(57) ABSTRACT

In one embodiment, a combined cooling and heating system comprises a hydrogen reservoir. The combined cooling and heating system may be used in an aircraft. During a charging of the hydrogen reservoir, with hydrogen, a kitchen appliance is heated, and during the discharging process, the hydrogen reservoir cools the fuel cell system.

### REFERENCE TO RELATED APPLICATIONS

This application claims the benefit of the filing date of U.S. Provisional Patent Application No. 60/820,122 filed Jul. 24, 2006 and of German Patent Application No. 10 2006 034 194.5 filed Jul. 24, 2006, the disclosures of which are hereby incorporated herein by reference.

### FIELD OF THE INVENTION

The field relates to cooling and heating systems. In particular, the field relates to a combined cooling and heating system, to an aircraft comprising a combined cooling and heating system, to the use of a combined cooling and heating system in an aircraft, and to a method for heating a first device and for cooling a second device by means of such a combined cooling and heating system.

### BACKGROUND OF THE INVENTION

Kitchens or galleys for mobile use require water and electrical energy for the preparation of food and beverages. Part of the electrical energy can also be replaced by heat if the heat is, for example, available as waste heat from some other application. However, as a rule, it may be difficult to match heat loads to the requirements of a galley so that this waste heat is not used, and instead the heat required in the preparation of food or beverages is generated, at the time when it is required, by means of electrical energy.

Furthermore, on board aircraft, fuel cell arrangements for obtaining water from the outgoing air of the fuel cells can be used. In this process, it may be necessary to condense the water contained in the outgoing air by means of a condenser.

For the purpose of condensing steam, a coolant circuit can be provided, to which two heat exchangers are coupled. These are for example, a primary heat exchanger and a secondary heat exchanger.

In this arrangement, condensation takes place by indirect cooling by means of a coolant that is ultimately cooled by outside air. This indirect cooling may be necessary to avoid icing up of the primary heat exchanger as a result of indirect contact with the outside air, where the temperature can be significantly below the freezing point of water. However, this design may be complex and may be associated with very considerable overall system mass.

### SUMMARY OF THE INVENTION

According to an embodiment of the combined cooling and heating system, a combined cooling and heating system comprises a hydrogen reservoir, wherein the combined cooling and heating system is designed for heating a first device by means of the hydrogen reservoir during charging of the hydrogen reservoir with hydrogen, wherein the combined cooling and heating system is designed for cooling a second device by means of the hydrogen reservoir during discharging of the hydrogen reservoir, and wherein the first device is designed to carry out an endothermic process, and the second device is designed to carry out an exothermic process.

In this way, waste heat and low temperature, which arise during charging or discharging of the hydrogen reservoir, may be used in a targeted manner so that the consumption of electrical energy may be reduced.

For example, when the hydrogen reservoir is charged with hydrogen, the combined cooling and heating system in one example can heat up a kitchen appliance such that food can be prepared. In contrast to this, when hydrogen is removed, a fuel cell system may be cooled such that condensation of water from the outgoing cathode air is accelerated without this requiring two heat exchangers. In particular, no cooling by outside air may be required. Instead, adequate cooling of the fuel cell system is provided solely by means of the hydrogen reservoir, which, for example, in normal operation is additionally used as a cooler.

According to a further embodiment of the combined cooling and heating system, the hydrogen reservoir is a metal-hydride reservoir.

In this example, safe hydrogen storage at high storage density and good cooling performance may be ensured.

According to a further embodiment of the combined cooling and heating system, the first device and the second device are arranged in a mobile system.

Such a mobile system, for example, may be a terrestrial vehicle, a water craft or an aircraft. As a result of the savings in weight that may be accomplished, the combined cooling and heating system may be particularly suited to the use in passenger aircraft. Additional cooling systems for cooling the cathode of the fuel cell system or of the fuel cell stacks may no longer be required.

According to a further exemplary embodiment of the combined cooling and heating system, the first device and the second device are arranged in a cabin of the aircraft.

The devices are thus located in a pressurised region of the aircraft; however, they may also be arranged in a non-pressurised region of the aircraft. Furthermore, the first (or the second) device may be located in a pressurised region, wherein the second (or the first) device is in a non-pressurised region.

According to a further exemplary embodiment of the combined cooling and heating system, the first device is a device in a galley region of the mobile system. For example, it can be a device for heating food or for heating beverages.

According to a further embodiment of the combined cooling and heating system, the first device is designed as a oven for heating food. According to a further embodiment of the combined cooling and heating system, the first device is designed as a scalding device for heating beverages.

In this arrangement, the required heating energy is provided by charging hydrogen into the hydrogen reservoir.

According to a further embodiment of the combined cooling and heating system, the second device is a fuel cell system, wherein the combined cooling and heating system is designed for cooling a fuel cell process of the fuel cell system.

Thus the cooling and heating system may be used in a first step as a heater for a kitchen appliance (namely during the refuelling process) and in a second step, as a cooler for the fuel cell stack or for other components of the fuel cell system (namely, during the removal of hydrogen). Additional heating devices or cooling devices may thus no longer be required.

According to a further embodiment of the combined cooling and heating system, the combined cooling and heating system is designed for cooling a condenser. Furthermore it may be designed for cooling or for pre-heating the fuel cell stack.

Furthermore, the hydrogen reservoir may be integrated in the fuel cell system. In this way an overall module may be provided that is installable as a continuous block in the aircraft. By integration of the hydrogen reservoir in the fuel cell system, the thermal contact between the fuel cell block and the hydrogen reservoir and/or between a condenser/condensate separator and the hydrogen reservoir may be improved. It may thus be possible to minimise heat losses or cold losses.

According to a further exemplary embodiment of the combined cooling and heating system, the cooling system is designed and capable of being regulated such that the heat arising when charging the hydrogen reservoir can be used for preheating the fuel cell system to operating temperature.

In this way, the heat energy released during charging of the hydrogen reservoir while the aircraft is on the ground, by intermediate storage or by direct transfer to the fuel cell system (for example, by way of direct thermal contact with the hydrogen reservoir), may be used for the purpose of the fuel cell system to reach its operating temperature. In this way, additional heating energy that would otherwise have to be provided by a further heating system may be saved.

According to a further exemplary embodiment of the combined cooling and heating system, the fuel cell system is designed to provide electrical energy and water.

According to a further exemplary embodiment of the combined cooling and heating system, furthermore, an electronic regulator unit for automatically controlling or regulating the cooling and heating system is provided.

Furthermore, according to a further exemplary embodiment of the combined cooling and heating system, the combined cooling and heating system comprises a unit for measuring a temperature of the fuel cell system and for transmitting the measured temperature to the electronic regulator unit.

Thus temperature data of the fuel cell system is acquired and transferred to the electronic regulator unit such that the cooling and heating system may be adjusted accordingly.

For example, the electronic regulator unit is designed for regulating the removal of hydrogen from the hydrogen reservoir as a function of the temperature of the fuel cell system or of the temperature of an oven or water heater.

For example, if the temperature of the fuel cell system is too low, the removal of hydrogen may be reduced so that cooling is reduced and the temperature of the fuel cells rises again. Additional hydrogen required by the fuel cell system can be taken from an intermediate hydrogen reservoir.

Furthermore, if heat energy for the first device is required, the hydrogen reservoir can be refuelled with hydrogen from a hydrogen storage tank.

According to a further exemplary embodiment of the combined cooling and heating system, an aircraft comprises a cooling and heating system as described above.

According to a further exemplary embodiment of the cooling and heating system, the use of such a cooling and heating system in an aircraft is stated.

Furthermore, a method for heating a first device and for cooling a second device by means of a combined cooling and heating system is stated, in which method, the first device is heated with hydrogen by means of a hydrogen reservoir during charging of the hydrogen reservoir, and the second device is cooled by means of the hydrogen reservoir during discharging of the of the hydrogen reservoir, wherein the first device is designed to carry out an endothermic process, and the second device is designed to carry out an exothermic process.

Further exemplary embodiments and advantages of the cooling and heating system are stated in the subordinate claims.

Below, with reference to the figures, exemplary embodiments of the cooling and heating system are described.

### BRIEF DESCRIPTION OF THE FIGURES

FIG. 1 shows a diagrammatic view of a combined cooling and heating system according to an embodiment of the cooling and heating system.

FIG. 2 shows a flow chart of a process according to an embodiment of the cooling and heating system.

### DETAILED DESCRIPTION

The examples described and the drawings rendered are illustrative and are not to be read as limiting the scope of the invention as it is defined by the appended claims.

The illustrations in the figures are diagrammatic and not to scale. In the following description of the figures, the same reference characters are used for identical or similar elements.

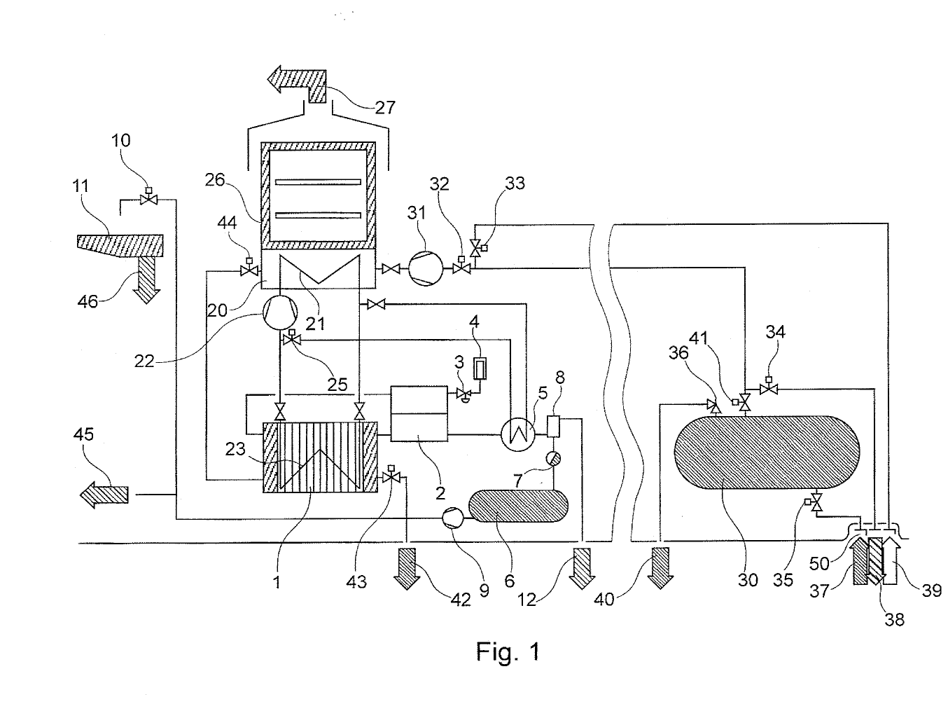

FIG. 1 shows a diagrammatic view of a combined cooling and heating system that is, for example, installed in an aircraft. In this arrangement, the combined cooling and heating system comprises a hydride reservoir 20, a first integrated heat exchanger 21, a second integrated heat exchanger 23, a coolant compressor 22 and an associated coolant circuit.

Hydrogen reservoirs, in particular metal-hydride reservoirs, have the characteristic of releasing thermal energy when hydrogen is placed into them, and of taking up thermal energy when hydrogen is taken from them. The temperature ranges relevant to this directly depend on the type of the hydride; they may be matched to the respective application.

In the combined cooling and heating system of FIG. 1 this characteristic is used to heat an oven for preparing food, or to cool a fuel cell stack 1 and a water condenser 5. In this context, the oven 26, the fuel cell stack 1, and the water condenser 5 are examples of any number and type of any other devices that are to be heated or cooled, which devices can also be elements of this arrangement.

Starting with an already filled hydrogen storage tank 30, the hydride reservoir 20 is charged by way of the compressor 31. In this process, the temperature in the hydride reservoir 20 rises. The available quantity of heat is matched to the oven 26 that is located above the hydride reservoir 20 such that the quantity of heat is sufficient to prepare food. This may, for example, be achieved by suitable dimensioning of the hydride reservoir 20.

Furthermore, a heat reservoir or a heat buffer can be provided that allows for delayed release of the heat that arises in this process. After completion of the charge process, the then filled hydride reservoir 20 is discharged by way of the fuel cell stack 1. As a result of this, the temperature of the hydride reservoir 20 drops. This temperature reduction is then used for cooling the connected fuel cell stack 1, wherein a coolant is pumped by way of the compressor device 22 by the heat exchangers 21 and 23.

By way of the control valve 25, a second circuit can be supplied with coolant, where second circuit feeds the condenser 5. In this process, the outgoing cathode air from the fuel cell 1, which air moves from the fuel cell stack by way of the cathode air humidifier 2 to the condenser 5, is cooled, wherein the water contained in the outgoing cathode air condenses out, is separated from the air stream by way of a condensate separator 8, and is fed by way of the condensate trap 7 to a buffer water tank 6. From there the water can be fed to the water system 10, 11, 45 by way of the pump 9, and after use can become waste water. The waste water supply is designated 46.

The electrical energy generated during operation of the fuel cell 1 can be supplied to further cabin applications, for example to water heaters, coffee machines or refrigeration devices for trolleys containing food.

The oxygen required to supply the fuel cell 1 may obtained from the air. In this process, in an aircraft, preferably the air mass stream from the cabin to the outside air, is used. This may result in a pressure difference. In the example shown, the cabin air is fed to the cathode air humidifier 2 by way of the air filter 4 and the flow control valve 3 and thereafter is fed to the fuel cell stack 1. At the cathode outlet of the fuel cell 1, the outgoing cathode air, as described above, is again fed through the cathode air humidifier 2, then through the water condenser 5 and the condensate separator 8 before it is discharged to the outside air. This is shown by reference character 12.

In a corresponding parallel arrangement and coupling of two or more systems, there is the option of out-of-phase operation of these systems and thus, continuous use of all the functions offered. In this arrangement, a first hydride reservoir can be charged while a second hydride reservoir is discharged, such that the thermal output and the temperature reduction that are required at the time occur. By a corresponding selection of reservoir sizes, it the fuel cell stacks also may be in continuous operation.

Furthermore, an outlet valve 44 for the hydride reservoir, an outlet valve 43 for the outlet line 42 of the fuel cell stack 1, a safety valve 36 for the outlet line 40 of the hydrogen storage tank 30, a check valve 41 for the hydrogen storage tank 30, a check valve 32 for regulating the charging of hydrogen, a check valve 33 for the flush-gas inlet 39 on the hydrogen refuelling panel 50, a check valve 34 for the flush-gas outlet 38 on the hydrogen refuelling panel 50, and a check valve 35 for the hydrogen inlet 37 of the hydrogen storage tank 30 are provided. Of course, still further valves may be provided in order to ensure safe and effective regulation of the system.

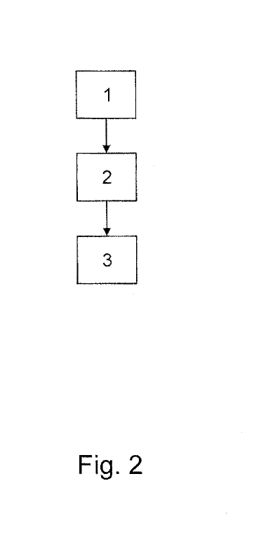

FIG. 2 shows a flow chart of a method for heating a first device and for cooling a second device by way of a combined cooling and heating system. It should be noted that the first device can be different from the second device.

However, the first device may also be identical to the second device (for example in the form of a fuel cell stack).

In a first step, the hydrogen reservoir 20 is charged with hydrogen, so that the first device is heated up. For example, the first device is an oven or a heat buffer or a fuel cell stack that is to be preheated prior to start-up.

In a second step, for example following start-up of the fuel cell stack, cooling of the second device takes place by way of the hydrogen reservoir, during discharging of the hydrogen reservoir. The second device is, for example, a component of a fuel cell system, for example, a fuel cell stack, an individual fuel cell of a condenser or water separator, or the air fed to the fuel cell.

In this arrangement, the first device is designed to carry out an endothermic process, and the second device is designed to carry out an exothermic process.

In addition, it should be pointed out that “comprising” does not exclude other elements or steps, and “a” or “one” does not exclude a plural number. Furthermore, it should be pointed out that characteristics or steps which have been described with reference to one of the above exemplary embodiments can also be used in combination with other characteristics or steps of other exemplary embodiments described above. Reference characters in the claims are not to be interpreted as limitations.

Alternative combination and variations of the examples provided will become apparent based on this disclosure. It is not possible to provide specific examples for all of the many possible combinations and variations of the embodiments described, but such combinations and variations may be claims that eventually issue.

### LIST OF REFERENCE CHARACTERS

1 Fuel cell stack

2 Cathode air humidifier

3 Flow control valve

4 Air filter

5 Water condenser

6 Buffer water tank

7 Condensate trap

8 Condensate separator

9 Pump

10 Water tap

11 Wash basin

20 Hydride reservoir

21 Integrated heat exchanger 1

22 Coolant compressor

23 Integrated heat exchanger 2

25 Coolant-circuit control valve

26 Oven

27 Warm outgoing air

30 Hydrogen storage tank

31 Compressor

32 Check-valve hydrogen charging

33 Check-valve flush-gas inlet

34 Check-valve flush-gas outlet

35 Check-valve hydrogen refuelling

36 Safety valve

37 Hydrogen inlet

38 Flush-gas outlet

39 Flush-gas inlet

40 Outlet line

41 Check-valve hydrogen

42 Outlet-line fuel cell stack

44 Outlet-valve hydride reservoir

45 Further water consumers

46 Wash basin outlet

50 Hydrogen refuelling panel

What is claimed is:

1. A combined heating and cooling system, comprising:
a hydrogen reservoir;
wherein the combined cooling and heating system is capable of heating a first device using the hydrogen reservoir during charging of the hydrogen reservoir with hydrogen;
the combined cooling and heating system is capable of cooling a second device using the hydrogen reservoir during discharging of the hydrogen reservoir;
the first device is capable of performing an endothermic process;
the second device is a fuel cell system;
the combined cooling and heating system is capable of cooling a fuel cell process of the fuel cell system; and
the second device is capable of performing an exothermic process.

2. The combined cooling and heating system of claim 1,
wherein the hydrogen reservoir is a metal-hydride reservoir.

3. The combined cooling and heating system of claim 1,
wherein the first device and the second device are arranged in a mobile system.

4. The combined cooling and heating system of claim 3,
wherein the mobile system is an aircraft.

5. The combined cooling and heating system of claim 4,
wherein the first device and the second device are arranged in a cabin of the aircraft.

6. The combined cooling and heating system of claim 1,
wherein the first device is a device in a galley region of the mobile system.

7. The combined cooling and heating system of claim 1,
wherein the first device is designed for heating at least one of heating food and heating beverages.

8. The combined cooling and heating system of claim 1,
wherein the first device for heating food is designed as an oven.

9. The combined cooling and heating system of claim 1,
wherein the first device for heating drinks is designed as a scalding device.

10. The combined cooling and heating system of claim 1,
wherein the combined cooling and heating system is designed for cooling a condenser.

11. The combined cooling and heating system of claim 1,
wherein the fuel cell system is designed to provide electrical energy and water.

12. The combined cooling and heating system of claim 1, further comprising:
an electronic regulator unit for automatically controlling or regulating the cooling and heating system.

13. The combined cooling and heating system of claim 11, further comprising:
a temperature measuring unit for measuring a temperature of the fuel cell system and for transmitting a measured temperature to the electronic regulator unit.

14. An aircraft comprising a combined cooling and heating system of claim 1.

15. A method for heating a first device and for cooling a second device using a combined cooling and heating system, the combined cooling and heating system comprising a hydrogen reservoir comprising:
heating the first device using a hydrogen reservoir during charging of the hydrogen reservoir with hydrogen;
cooling the second device using the hydrogen reservoir during discharging of the hydrogen reservoir;
wherein the first device is capable of performing an endothermic process; and
the second device is capable of performing an exothermic process;
the second device is a fuel cell system; and the combined cooling and heating system is capable of cooling a fuel cell process of the fuel cell system.
